(19) United States
(12) Patent Application Publication
(10) Pub. No.: US 2009/0297011 A1
(43) Pub. Date: Dec. 3, 2009

(54) METHOD FOR OBTAINING A 3D (CT) IMAGE USING A C-ARM X-RAY IMAGING SYSTEM VIA ROTATIONAL ACQUISITION ABOUT A SELECTABLE 3D ACQUISITION AXIS

(76) Inventors: Thomas Brunner, Nurnberg (DE); John Christopher Rauch, Savoy, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/128,086

(22) Filed: May 28, 2008

(51) Int. Cl. G06K 9/00

(52) U.S. Cl. 382/132

(57) ABSTRACT

In a method for acquiring a 3D image rotational acquisition and reconstructed 3D image of an examination subject in whom a highly dense object is located, the 3D acquisition axis for acquiring the 3D image rotational acquisition is selected prior to acquisition, such that the orientation of the region of interest with respect to an artifact inducing object is not perpendicular to the 3D acquisition axis.

### BACKGROUND OF THE INVENTION

1. Field of the Invention

The present invention concerns the acquisition of 3D (CT) images using a c-arm x-ray imaging system, and in particular a method for obtaining 3D (CT) images wherein obscuring effects in the 3D (CT) image due to dense (radio-opaque) objects in the examination subject can be shifted away from an area of interest.

2. Description of the Prior Art

In conventional c-arm x-ray imaging systems, the 3D acquisition axis is fixed. The 3D acquisition axis is the axis about which the x-ray source and radiation detector, held in fixed geometry by the c-arm, rotate. This means that the metal artifact in the 3D (CT) image is fixed, and largely constrained to the planes containing the object generating the artifact and perpendicular to the 3D acquisition axis.

It is often the case that the examination subject of whom a 3D (CT) image is to be obtained has radio-opaque objects in his or her body, typically metallic objects such as dental fillings, aneurysm clips or stents, screws, plates, etc. Such objects are highly dense resulting in high x-ray absorption and in deflection or scatter of the x-rays directed at these objects. The deflected and scattered x-rays are picked up by the detector at various locations other than their anticipated path from the source to the detector. While some scatter is expected, the increased scatter due to the presence of highly dense objects in the subject being imaged will result in an artifact degrading the quality of the image. This artifact is manifested in the 3D (CT) image as lines emanating from and extending radially away from the object. The artifact raises the intensity values of the voxels along these lines with a maximum increase in intensity proximal to the object and decreasing intensity moving away from the object. The representation in such a 3D (CT) image will be referred to herein as a “metal artifact”. The metal artifact is most pronounced adjacent to the objects creating the artifact and is worst in the planes that are perpendicular to the 3D acquisition axis.

If the region of interest in the examination subject happens to lie adjacent to a highly dense object and in a direction perpendicular to the 3D acquisition axis, the metal artifact in the image can significantly degrade, and even preclude, an accurate diagnosis of the region of interest from being made in the resulting reconstructed 3D image. (See FIG. 2) When a 3D (CT) image is obtained, from a conventional c-arm x-ray imaging system capable of 3D image acquisitions, that contains metal artifact that precludes clear visibility of a desired region of interest in the 3D (CT) image, the response has been to reposition the patient relative to the 3D acquisition axis so as to try to place the patient in a position wherein the 3D acquisition axis is more parallel to the line that proceeds through the region of interest and through the radio-opaque object. Often this requires repositioning the patient on the table in a manner that is not normal or is uncomfortable. For example, to alleviate the effect of a metal artifact produced by dental fillings, the head of the examination subject may be tilted superiorly or inferiorly to shift the metal artifact produced by dental fillings away from a particular region of interest, such as the base of the skull or the carotid arteries. (See FIG. 3) This option is not always available, as it is not always possible to reorient the patient's anatomy with respect to the table. In the afore-mentioned example, tilting the patient's head could be hindered by the presence of a breathing tube or may be precluded by a need to maintain patient's current positioning.

A new series (family) of interventional imaging system has been developed by Siemens Healthcare that can be used for multiple types of imaging, including angiography, fluoroscopy and radiography (CT). This system is known as the Artis zee system. The basic components of this system are shown in FIG. 1. The system includes a robotic C-arm device 1, which has a multi-axis robot 2 to which a C-arm 3 is mounted. The C-arm 3 is movable in the conventional manner (i.e., orbital movement and rotational movement), but the overall orientation of the C-arm 3 can be selectively adjusted in space by the multi-axis robot 2. The rotation and orbital movements of the C-arm 3 itself are effected at the “wrist” of the robot 2, and the two-part “arm” of the robot 2 is articulated at an “elbow” joint, and is also articulated at a “shoulder” joint, where the “arm” is attached to the base. The base is rotatable around a vertical axis proceeding perpendicular to the floor on which the base rests.

The C-arm 3 carries an x-ray source 4 and a radiation detector 5 at the opposite free ends thereof. The aforementioned adjustment possibilities of the robotic C-arm 1 allow the x-ray source 4 and the radiation detector 5 to assume virtually any position with respect to a patient bed 6, on which an examination subject lies. All movements as well as the image acquisition are controlled by a control computer 7, with the resulting image or images being displayed at a monitor 8 that is in communication with the control computer 7.

The Artis zee system can be operated with DynaCT software, also commercially available from Siemens Healthcare, which allows the system to be operated in a CT mode or in a fluoroscopy mode. The radiation detector 5 is a flat panel radiation detector that is used to detect radiation attenuated by the examination subject in each of these modes. As originally contemplated, the C-arm 3 in the fluoroscopy mode is held in a stationary position by the robot 2 so that the fluoroscopy image is obtained in the conventional manner along a fixed 3D acquisition axis. When switched to operation in the CT mode, however, the robotic C-arm 1 is adjusted to place the C-arm 3 in a desired, selected orientation for acquisition of the CT image, and then the C-arm 3 is rotated through multiple projection angles to acquire the CT data (projection datasets), from which the CT image is then reconstructed using a known CT reconstruction algorithm.

### SUMMARY OF THE INVENTION

It is an object of the present invention to provide a method for obtaining 3D (CT) images acquired on a c-arm x-ray imaging system wherein metal artifact is significantly reduced within a specified region of interest in the 3D (CT) image volume.

The above object is achieved in accordance with the present invention by a method for specifying the 3D acquisition axis—the axis about which the imaging system will rotate the c-arm to acquire the data for 3D image reconstruction. The location of the metal artifact in the reconstructed 3D image is determined by the location of the object generating the artifact and the orientation of the 3D acquisition axis. Changing the orientation of the 3D acquisition axis will change the location in the reconstructed 3D image in which metal artifact is present.

This is analogous to adjusting the orientation of the subject on the table, as discussed earlier (see FIG. 3), except that the subject remains unmoved and the orientation of the 3D acquisition axis changes with respect to the subject (see FIG. 4). This new method for shifting metal artifact in reconstructed 3D images is preferable, as it is not always possible or convenient to reorient the patient on the table.

The methods by which the user may be able to specify a 3D acquisition axis may include: selection of an axis among a set of common axes, user adjustment of the c-arm to establish the axis, selection of a region of interest to be removed of metal artifact in a 3D image that results in the imaging system automatically computing a new axis, user specification of an axis on an image from a previously reconstructed 3D image, or some combination of the afore mentioned.

Selection of a 3D acquisition axis will be prohibited if the system determines that it will cause the rotation of the c-arm to collide with the patient, patient table, or other portion of the imaging system. Additional considerations will be taken to ensure that a selected 3D acquisition axis will not collide with the operator, staff, or ancillary equipment.

The implementation of an adjustable 3D acquisition axis for a c-arm imaging system is preferentially implemented using an imaging system with robust c-arm positioning capability, such as the Siemens AG Artis Zeego system.

### BRIEF DESCRIPTION OF THE DRAWINGS

FIG. 1, as noted above, schematically illustrates the basic components of a robotic C-arm system suitable for use in accordance with the inventive method for obtaining fluoroscopy exposures.

FIG. 2 schematically illustrates in a planar view of a 3D reconstructed image how the orientation of the 3D acquisition axis can result in the presence of metal artifact in the reconstructed 3D image that obscures the a region of interest.

FIG. 3 schematically illustrates in a planar view of a 3D reconstructed image how the subject may be repositioned or reoriented to shift the metal artifact away from a region of interest to another location.

FIG. 4 schematically illustrates in a planar view of a 3D reconstructed image how the 3D acquisition axis may be repositioned or reoriented to shift the metal artifact away from a region of interest to another location.

### DESCRIPTION OF THE PREFERRED EMBODIMENTS

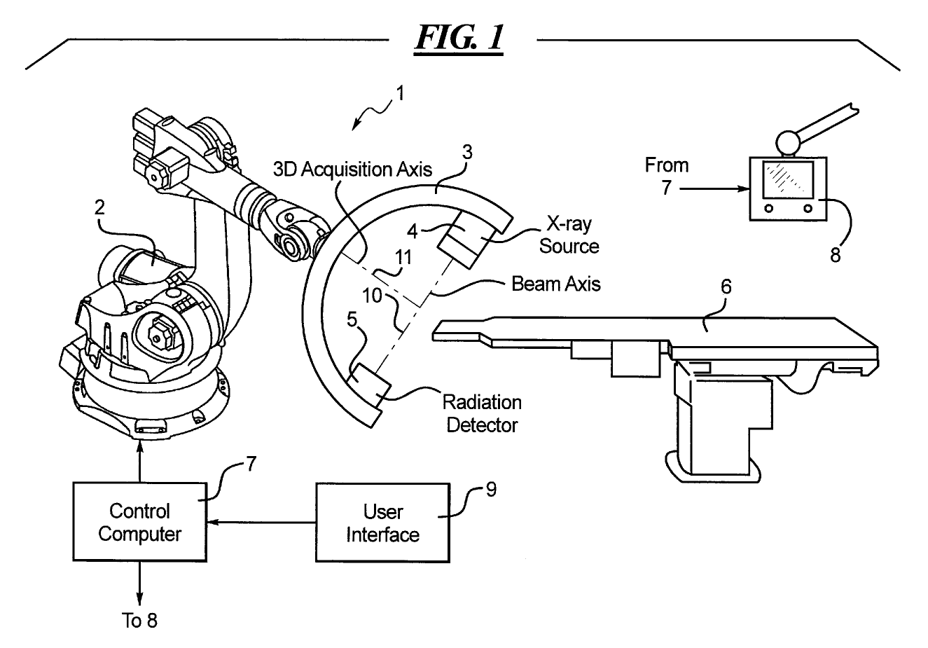

In a preferred embodiment, a robotic C-arm system 1 of the type schematically shown in FIG. 1 is used to obtain a reconstructed 3D image of an examination subject on the patient bed 6. For this purpose, an operator makes suitable entries into the control computer 7 via a user interface 9 to select operation of the 3D acquisition mode and to position the C-arm 3 in an orientation that positions the 3D acquisition axis (not shown) such that the orientation of the region of interest with respect to an artifact inducing object is not perpendicular to the 3D acquisition axis.

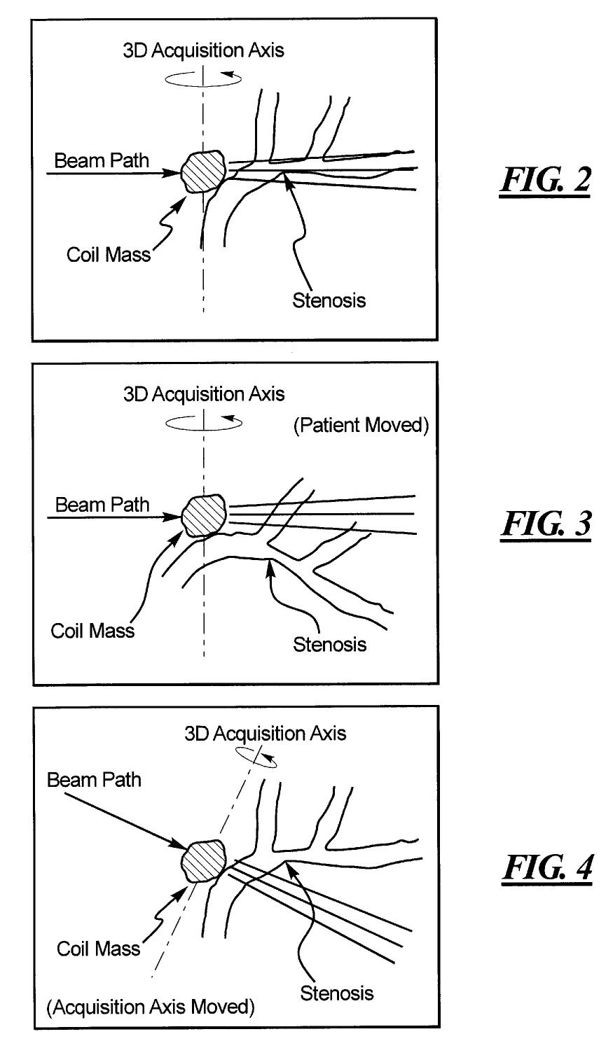

An example of the application of the method in accordance with the present invention for obtaining a reconstructed 3D image of a stenosis in an examination subject, in whom a radio-opaque object is also present, is illustrated in FIGS. 2, 3, and 4.

As shown in FIG. 2, in this example the examination subject has a previously-implanted platinum coil, which has been implanted in order to treat an aneurysm. The platinum coil mass is located in close proximity to a vessel, which contains a stenosis. It is desired to obtain a 3D reconstructed image of the examination subject that accurately depicts the vessel containing the stenosis along with its location with respect to the coil mass and other anatomy. This image will could be used to quantify the stenosis and evaluate treatment options (e.g. angioplasty, stenting, or stenting with angioplasty).

FIG. 2 schematically illustrates the situation that could occur in a conventional system, wherein the 3D acquisition axis is fixed. As shown in FIG. 2, it is possible that the stenosis will lie behind the coil mass, along the beam path, and perpendicular to the 3D acquisition axis-producing metal artifact in the reconstructed 3D image that would obscure the stenosis. Conventionally, this would require, if possible, repositioning of the patient in order to create a patient geometry wherein the stenosis does not lie perpendicularly to the coil mass with respect to the 3D acquisition axis (see FIG. 3).

As schematically indicated in FIG. 4, the avoidance of an obscuring metal artifact in the reconstructed 3D image is achieved in accordance with the present invention, without the necessity of repositioning the examination subject, by changing, or initially setting, the 3D acquisition axis. This allows the region of interest containing the stenosis to be clearly seen in the resulting reconstructed 3D image. The metal artifact produced by the coil mass will still occur in the resulting reconstructed 3D image, but it will not have an obscuring effect on the region of interest.

The appropriate setting of the position and orientation in space of the 3D acquisition axis is achieved in the preferred embodiment by either a manual or programmed operation of the robotic C-arm system 1 shown in FIG. 1, so that the 3D acquisition axis (not shown) coincides with the schematically indicated 3D acquisition axis in FIG. 4 (in this example).

The user interface 9 allows the user to select the 3D acquisition axis. This can be done in a number of ways. For example, the user can select the 3D acquisition axis from among a number of preset acquisition axes. Alternatively, the operator can adjust the robotic C-arm system 1 manually prior to initiating the 3D image rotational acquisition. This can be done by specifying a 3D acquisition axis based on the operator's knowledge or experience, or by viewing a previously acquired 3D image of the subject. It is also possible to adjust and interact with slice orientations of a previously acquired 3D image to specify a new 3D acquisition axis.

Another possibility is for the operator to designate the region of interest in a previously reconstructed 3D image, and the control computer 7 then automatically determines adjustment settings for the robotic C-arm 1 that will result in a 3D acquisition axis that minimizes metal artifacts in the region of interest generated by dense objects in the examination subject, with the identification of these objects being performed either by the user or automatically by the control computer. The control computer 7 can then also automatically adjust the position of the robotic C-arm 1 to conform to the automatically determined setting.

It is also possible to employ any combination of the above alternatives. Once an adequate 3D acquisition axis has been identified, the robotic C-arm system can perform a 3D image rotational acquisition that will enable a 3D image to be reconstructed, wherein metal artifact is shifted away from a specified region of interest in the examination subject.

In theory, the robotic C-arm system 1 (or whatever imaging system is used) can be arbitrarily positioned so as to similarly arbitrarily position the 3D acquisition axis (not shown). In practice, however, collisions with the patient, attending personnel, the patient bed 6 and other items that may be present in the environment of the imaging system must be avoided. Known collision-avoidance algorithms can be used in combination with any of the above-described alternatives for positioning the 3D acquisition axis (not shown) that would preclude the C-arm 3 of the robotic C-arm system 1 from moving through, or assuming, a position at which a collision would occur.

It is of course also possible that once the robotic C-arm 1 (or whatever imaging system is used) has been brought to the intended position, the operator can be permitted to manually make “fine tuning” adjustments, as may be necessary.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for acquiring a 3D rotational image acquisition and 3D image reconstruction of an examination subject, comprising the steps of:
placing an examination subject, having a radio-opaque object therein, in an initial position on a patient support, said examination subject having a region of interest therein exhibiting an anatomical geometry when said patient is in said initial position;
selectively orienting a c-arm x-ray imaging system, having a 3D acquisition axis relative to the examination subject to selectively set a position and orientation of said 3D acquisition axis that does not orient the region of interest perpendicularly to said radio-opaque object with respect to said 3D acquisition axis, while maintaining said anatomical geometry substantially unchanged; and
operating said c-arm x-ray imaging system to obtain 3D rotational image acquisition data of the examination subject containing said region of interest with said 3D acquisition axis in said position and orientation; and
reconstructing a 3D image from said 3D rotational image acquisition data, wherein said radio-opaque object does not introduce metal artifact that occludes said region of interest in said 3D image.

2. A method as claimed in claim 1 comprising employing a C-arm x-ray imaging system operating in a 3D image acquisition mode as said imaging system to acquire said 3D image.

3. A method as claimed in claim 2 comprising selectively positioning said C-arm x-ray imaging system with a robot to set said position and orientation of said 3D acquisition axis.

4. A method as claimed in claim 1 comprising manually operating said imaging system to set said orientation and position of said 3D acquisition axis.

5. A method as claimed in claim 4 comprising presenting a menu of preset acquisition axes and allowing an operator to select one of said preset acquisition axes as said 3D acquisition axis for obtaining said fluoroscopic image.

6. A method as claimed in claim 5 comprising automatically positioning said imaging system to set said position and orientation of said 3D acquisition axis to conform to the selected one of said preset acquisition axes.

7. A method as claimed in claim 1 comprising, prior to acquiring said 3D image, displaying a previously acquired 3D image of said examination subject that shows said region of interest and said radio-opaque object.

8. A method as claimed in claim 7 comprising displaying said previously acquired 3D image in different slice orientations, allowing an operator to change the slice orientation, and allowing the user to specify a 3D acquisition axis upon the displayed 3D image slices.
